(19) United States
(12) Patent Application Publication
(10) Pub. No.: US 2003/0152449 A1
(43) Pub. Date: Aug. 14, 2003

(54) Manual tote

(76) Inventors: Bruce T. Marich, Brea, CA (US); Alan E. Hall, Brea, CA (US)

Correspondence Address: Cleveland R. Williams, Suite 100, 2501 East Chapman Avenue, Fullerton, CA, 92631, US

(21) Appl. No.: 10/073,382

(22) Filed: Feb. 12, 2002

(51) Int. Cl. B60P 9/00

(52) U.S. Cl. 414/462

(57) ABSTRACT

The present invention resides in a wheelchair lift/carrier for use in transporting a folded wheelchair on a motor vehicle trailer hitch. The wheelchair lift/carrier comprises a vertical support shaft attached to vertical trailer hitch on one side and to a rotate arm shaft on the other side with first rotation means. The rotate arm shaft is attached to a locking head near the top section thereof with second rotation means a swing arm shaft with third rotation means. An inverted T-shaped, bottom support shaft is attached to the bottom of the swing shaft, wherein said bottom support shaft containing front wheel and rear wheel support means for a wheelchair. Stabilizing guides, locking and unlocking means and linkage means form an integral part of the wheelchair lift/carrier.

### BACKGROUND OF THE INVENTION

1. Field of the Invention

This invention relates to a wheelchair lift/carrier that is mounted on the rear end of an automobile. More particularly, the invention relates to an externally mounted wheelchair carrier on the rear of an automobile that is adapted for use in transporting a wheelchair or similar device.

Individuals who use a wheelchair to move from place to place, e.g. locomotion, require special provision for transporting said wheelchair when taking an automobile trip for social, business or medical purposes. In the past a friend, relative or attendant of the wheelchair user would collapse the wheelchair and store it in the trunk or rear seat space of an automobile or in the storage or cargo area of a station wagon or utility vehicle which is used for transporting said wheelchair.

It has always been a difficult task to fold a wheelchair and place it inside an automobile. This situation is made more difficult with the downsizing of automobiles to meet federal regulations regarding fuel economy and automobile emissions.

This type of manipulation and handling of the average wheelchair requires considerable strength and dexterity because a wheelchair is inherently a heavy, bulky and awkward device. Often, the wheelchair user's aged spouse, friend or parent lacks the requisite strength and dexterity to place the wheelchair in the back of an automobile, station wagon or utility vehicle, thus reducing or restricting the frequency of trips for the incapacitated individual.

2. Description of the Prior Art

Various prior art devices have been provided for transporting a wheelchair or similar device from one location to another. Some prior art devices have been provided wherein the wheelchair is supported on some sort of carrier positioned on the rear end of an automobile.

For example, U.S. Pat. No. 4,775,282 to Van Vliet relates to a carrier mountable on the rear of a vehicle for carrying a conveyance for handicapped persons. The carrier contains a frame adapted to be attached to the conveyance. The conveyance is a three wheeled device that is electrically operated. A platform is slidably and hingeably attached to the frame. In a storage position, the platform is vertically positioned above the ground. The carrier includes a drive motor coupled between the frame and platform for lifting and lowering the platform to either load or unload the conveyance.

U.S. Pat. No. 4,438,875 to Fritsch discloses a wheelchair carrier suitable for use in transporting a wheelchair on an automobile bumper. The carrier device consists of a rigid basket framework and a coupling unit for releasably mounting the framework to the rear bumper of an automobile. In use, a wheelchair is collapsed and the wheelchair is lifted up by an individual and the rear wheels of said wheelchair are placed in the basket framework. Side and bottom restraints hold the wheelchair in position during transportation thereof.

U.S. Pat. No. 4,400,129 to Eisenberg et al. relates to a wheelchair carrier and loading device for carrying objects externally of a vehicle. The carrier includes a support member attached externally to the vehicle. A pivot member is pivotally mounted to the support member and is rotatable for accurate movement through an arc about an axis extending through a pivot member. The arc of rotation is between a vehicle carrying position and a receiving position at the end of the arc. A carrying device is attached to the pivot member fore receiving objects, such as a wheelchair, in the pivot member when in the receiving position thereby loading objects to the carrier for transport thereof.

U.S. Pat. No. 4,297,069 to Worthington discloses a wheelchair carrier for attachment to the rear of a motor vehicle. The carrier consists of a housing containing two verticle slide bars mounting a cross member therebetween for verticle displacement, a pair of rearwardly extending projections mounted on the cross member and a winch cable attached to the cross member to empart motorized verticle movement thereto. The projections can be inserted through appropriate openings in a wheelchair and the winch activated to lift the wheelchair under a receiving hood located on the housing member. A strap may be disposed about the wheelchair to hold it in secure engagement within the housing for transportation.

U.S. Pat. No. 4,697,975 to Lippold relates to a wheelchair carrier which is mounted on the rearwardly extending hitch of a motor vehicle. A platform is pivotably mounted on a horizontally extending support which is operatively mounted on the vehicle hitch. The platform may be pivotably moved from a horizontal carrying position to an inclined loading and unloading position. When in the inclined position, one end of the platform may be positioned beneath the handles of a folder wheelchair. Pivotal movement of the carrier from its inclined position causes the wheelchair to be lifted from the ground and positioned on the carrier.

As can be determined from the foregoing, there is an ongoing research effort and a need to develop and produce new and novel wheelchair carriers for use in conjunction with motor vehicles.

### SUMMARY OF THE INVENTION

The present invention resides in a wheelchair carrier suitable for external attachment to the rear of a motor vehicle. A fixed support unit, for example, a trailer hitch is attached to the rear of a motor vehicle. A primary vertical support shaft having an elongated configuration is removably attached to the fixed support unit using conventional means, e.g. nuts and bolts or a trailer hitch. An elongated rectangularly shaped rotate arm shaft is attached to a primary vertical support shaft with first rotation means near the bottom portion thereof. A handle containing a cam, having storage position lock means and handle lock means, is attached to the rotate arm shaft with second rotation means.

The rotate arm shaft may be rotated in a counter clock-wise arc up to 90 degrees or more. An off-set, elongated rectangularly shaped swing arm shaft is pivotally attached to the rotate arm shaft with third rotation means. A stabilizing linkage is pivotally attached to primary vertical support shaft at one end and to the swing arm shaft at the other end. A bottom support shaft having an inverted T-shaped configuration is attached to the bottom portion of the swing arm shaft. On one side of the support shaft there is attached a bottom support tray for receiving a wheelchair. On the other side of the bottom support shaft, there is a wheelchair rear support. A bundgy cord is removably attached to the top of the bottom support tray and the handle.

### BRIEF DESCRIPTION OF THE DRAWINGS

For a more complete understanding of the present invention, reference is now made to the following detailed description taken in conjunction with accompanying drawings in which:

FIG. 1 is a front perspective view of the wheelchair carrier in the storage position, wherein the handle is locked in the storage lock position.

FIG. 2 is a front view of the wheelchair carrier of FIG. 1 illustrating the wheelchair features from a front view.

FIG. 3 is a left side view of the wheelchair carrier of FIG. 1 illustrating the side features thereof.

FIG. 4 is a front perspective view of the wheelchair carrier of FIG. 1 in the storage position, wherein the handle is in the position unlocked (load/unload).

FIG. 5 is a front perspective view of the wheelchair carrier of FIG. 1. In the loading position, wherein the rotate arm shaft has been rotated in a counter-clockwise arc from the primary vertical support shaft.

FIG. 6 is a side perspective, cut-away view of the handle locking mechanism.

FIG. 7 is another side perspective, cut-away view of the handle locking mechanism of FIG. 6 further showing the biased spring unit of the handle locking mechanism.

### DETAILED DESCRIPTION OF THE INVENTION

The present invention relates to a wheelchair lift/carrier that is mounted externally on the rear end of a motor vehicle.

Embodiments of the wheelchair lift/carrier of the present invention are hereinafter described with reference to the drawings, in which identical or corresponding parts are indicated by the same reference characters or numbers through the several views.

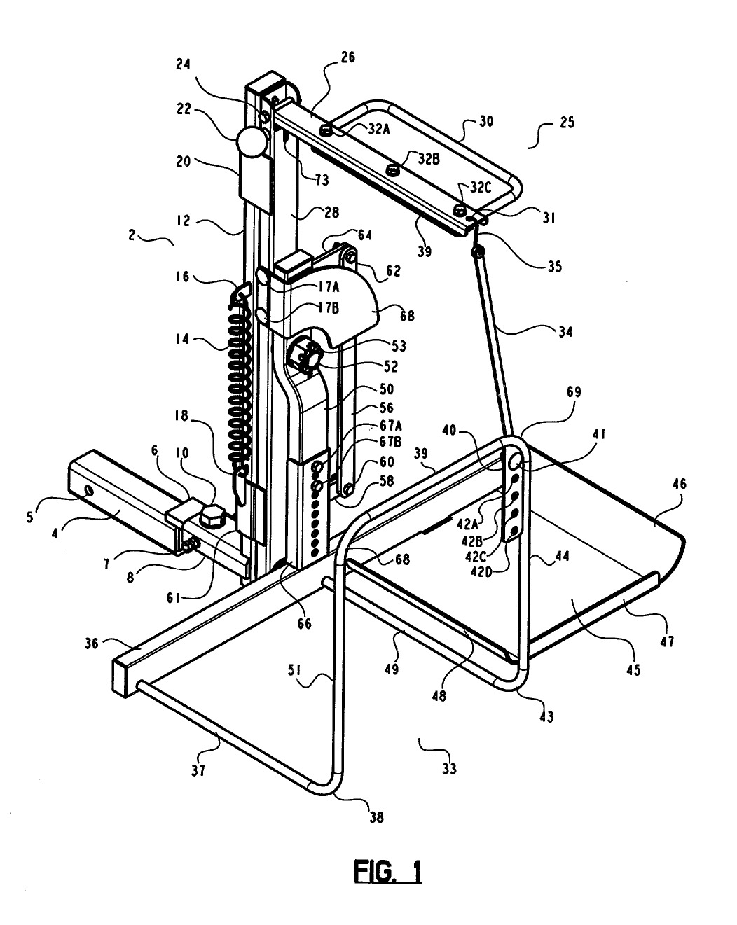

FIG. 1 illustrates a front perspective view of the wheelchair lift/carrier (2) in the storage position. Wheelchair lift/carrier (2) has a main mast or primary vertical support shaft (12) which has an elongated rectangular shape or configuration. Vertical support shaft (12) contains a horizontal attachment shaft (8) on the lower back side thereof. Attachment shaft (8) attaches to motor vehicle trailer hitch (4) by bolts (7) and (10). Top attachment plate (6) secures vertical support shaft (12) to trailer hitch (4). Round hole (5) in trailer hitch (4) receives a bolt (not shown) for stabilization and attachment purposes.

Swivel mast or rotate arm shaft (28) is rotatably attached to the front of vertical support shaft (12) near the bottom portion thereof with first rotation means. Rotating arm shaft (28) has an elongated rectangular shape or configuration. Lower stabilizing guide (61) is attached to rotate arm shaft (28) and passes along the back side of vertical support shaft (12). Stabilizing guide (61) contains lower spring bracket (18) which contains an eye-let near the top portion thereof for receiving the bottom end of spring (14). Upper spring bracket (16) which is attached to the left side of vertical support shaft (12) contains an eye-let for receiving the top end of spring (14). It should be noted that spring (14) is preferably a coiled metal spring with sufficient bias to aid in lifting a wheelchair. Top stabilizing guide (20) is attached to rotate arm shaft (28) near the top, left side portion thereof. Locking knob (22) is located just above top stabilizer guide (20) on the left side of rotate arm (28). Top stabilizer guide (20) has an L-shaped, rectangular configuration.

Locking head (25) is attached to the top front portion of rotate arm (28) with second rotation means (24). Second rotation means (24) is a pivot pin. Locking head (25) contains handle (30) which is a circular shaped shaft having an inverted C-shaped configuration. Handle (30) is attached to top support shaft (26) which has an elongated rectangular configuration with a channel contained on the bottom portion thereof. Pad (39) fits into the channel located on the bottom of top support shaft (26) and fits on the top of a wheelchair to secure it and act as a stabilizer in the storage/carrying position. Rotate arm shaft (28) contains a slot (73) for receiving a cam (not shown) attached to the back portion of the top support shaft (26).

Swing arm shaft (50) is an off-set elongated rectangularly shaped shaft that is pivotally attached to rotate arm shaft (28) with third rotation means. Third rotation means is a pivot pin (52) which attaches rotate arm shaft (28) to swing arm shaft (50).

Intermediate stabilizing guide (68) contains an L-shaped configuration having a rectangular shape on one side and a cam like shape on the adjacent side. Intermediate stabilizing guide (68) is attached to rotate arm shaft (28) with bolts (17A & B). Linkage (56) is pivotally attached to L-shaped support arm (58) at one end by pivot pin (60) and to support arm (64) by pivot pin (62) at the other end. Linkage (56) stabilizes and maintains body attitude of swing arm shaft (50) as rotate arm shaft (28) is rotated counter clock wise front the storage position to the loading position for a wheelchair.

An inverted T-shaped bottom support shaft (36) is attached to the lower portion of swing arm shaft (50) by bolts (67A & B). Bottom support shaft (36) contains a plurality of adjustment holes drilled along the vertical axis of the top portion of said inverted T-shaped bottom support shaft (36).

Tray (45) is attached to the right side of the front of bottom support shaft (36). Tray (45) contains right flange (46) and left flange (48) which have circular configurations. Front strap (47) of tray (45) has an elongaed rectangular configuration and acts as a stop in conjunction with right flange (46) and left flange (48) for the front wheels of a folded wheelchair.

Wheelchair rear wheel support (33) has a circular shaped configuration which fits on the left side of bottom support shaft (36). Rear wheel support shaft (33) contains two horizontal circular support shafts (37 and 46) which are parallel to each other and spaced apart. Left shaft (37) forms a vertical elbow bend (38) at the front thereof and attaches to front vertical circular shaft (51). Right shaft (49) forms a vertical elbow bend at (43) and attaches to vertical circular shaft (44). The top of left vertical circular shaft (51) forms a horizontal elbow bend (68) and the top of right vertical circular shaft (44) forms horizontal elbow bend (68). The two horizontal elbow bends (44 and 68) are attached to horizontal circular shaft (39) to complete the configuration of the wheelchair rear support (33). It is to be noted that rear support (33) is particularly designed to receive the large rear wheels of a variety of wheelchairs.

A safety strap adjustment plate (40) is attached to the top portion of the right vertical shaft (44). Safety strap adjustment plate (40) contains a plurality of adjustment holes 42 (A to D) for receiving bundgy card (34). Bundgy card (34) is attached to safety strap adjustment plate by bolt (41). The top of bundgy card (34) is releasably attached at end hook (35) to eye-let (31) located near the front of locking head (25).

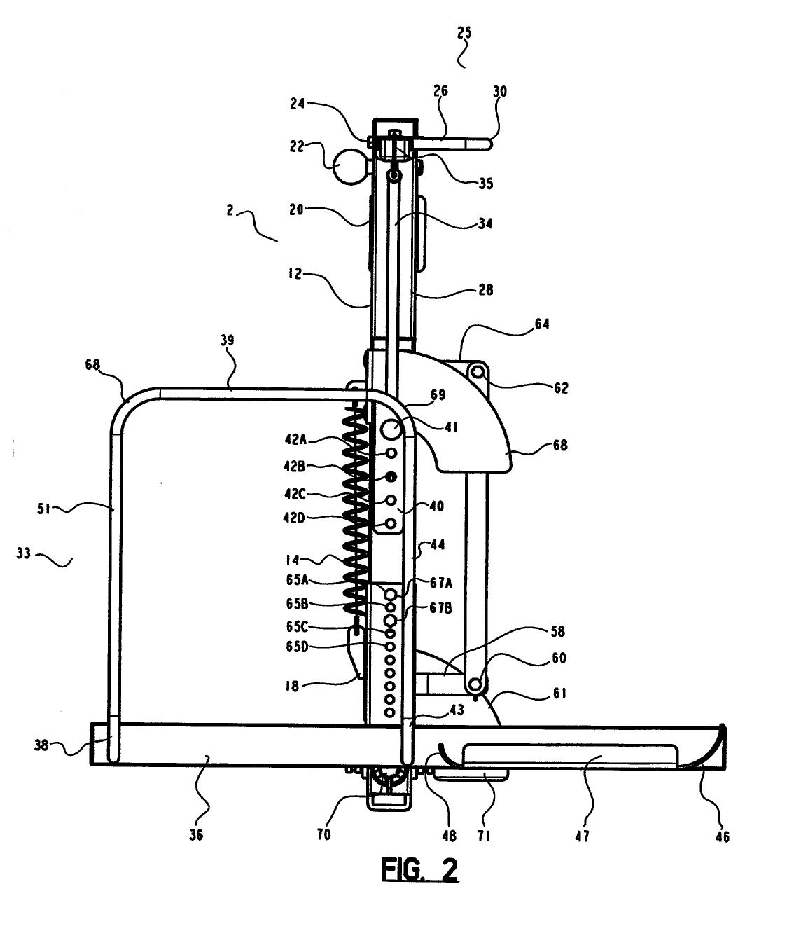

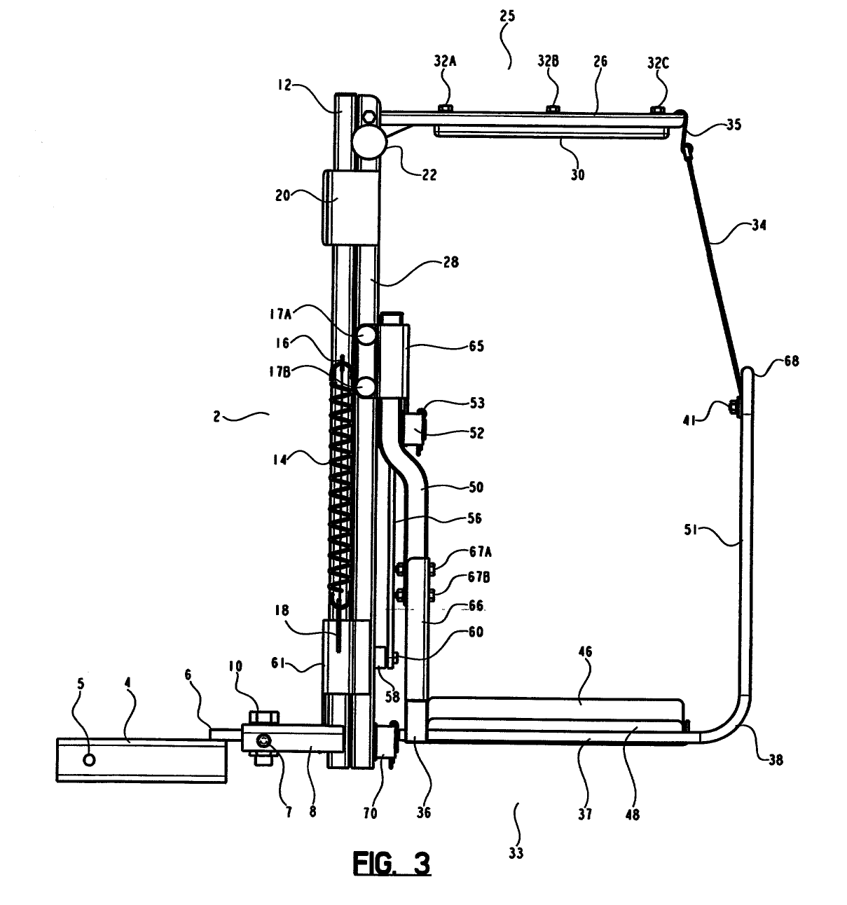

FIGS. 2 and 3 are front and side views respectively of the view illustrated in FIG. 1, wherein wheelchair lift/carrier is in the support, transportation position The numerals illustrating the various elements of the invention are substantially the same with the following exceptions:

A plurality of adjustment holes 65 (A to D) are located on inverted T-shaped bottom support shaft (36) for attaching to off-set swing arm shaft (50) in FIG. 2. The cam shaped configurations of bottom stabilization guide (63) and intermediate stabilization guide (68) are shown in greater detail.

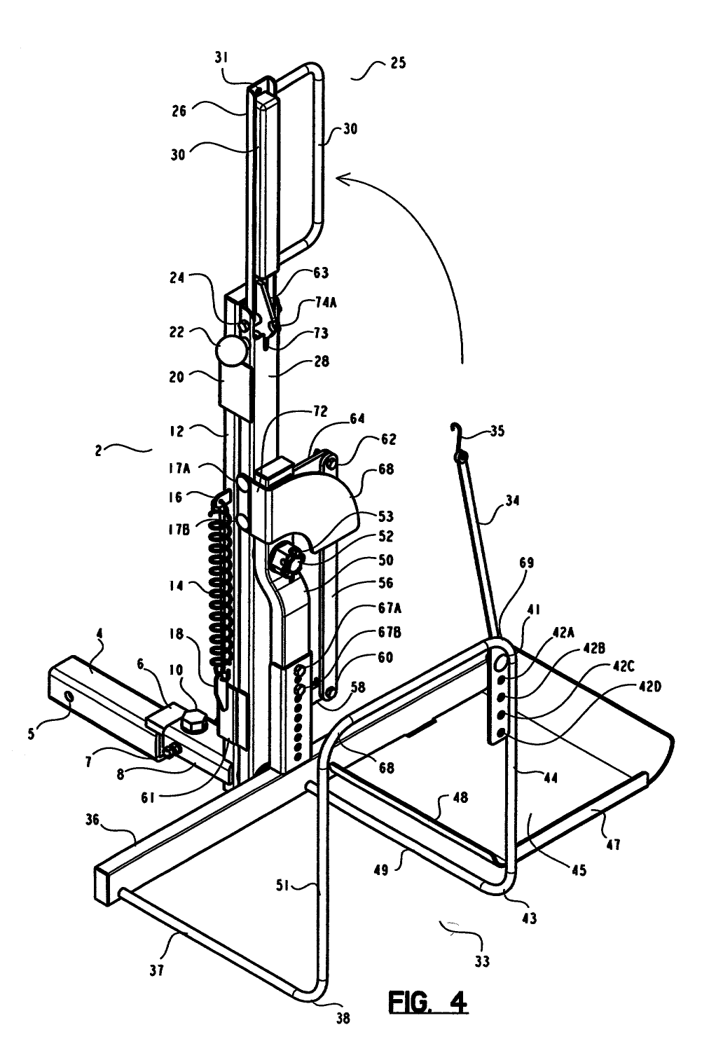

FIG. 4 is yet another view of the wheelchair lift (2) of FIG. 1 with the following exceptions:

Bundgy cord (34) has been disconnected from locking head (25) and locking head (25) has been rotated into the handle up lock position. Cam (76), which is attached to top support shaft (26) has been rotated through slot (73) to the handle lock position by applying pressure on knob (22).

FIG. 4 also shows the first rotation means (24) which pivotably connects lock arm (25) to rotate arm shaft (28) is shown, as well as support pad (30). It is to be noted that support pad (30) is preferably constructed from plastic, rubber, etc. A preferred material is urathane. A substantial portion of the material from which wheelchair lift/carrier (2) is constructed is preferably a metal.

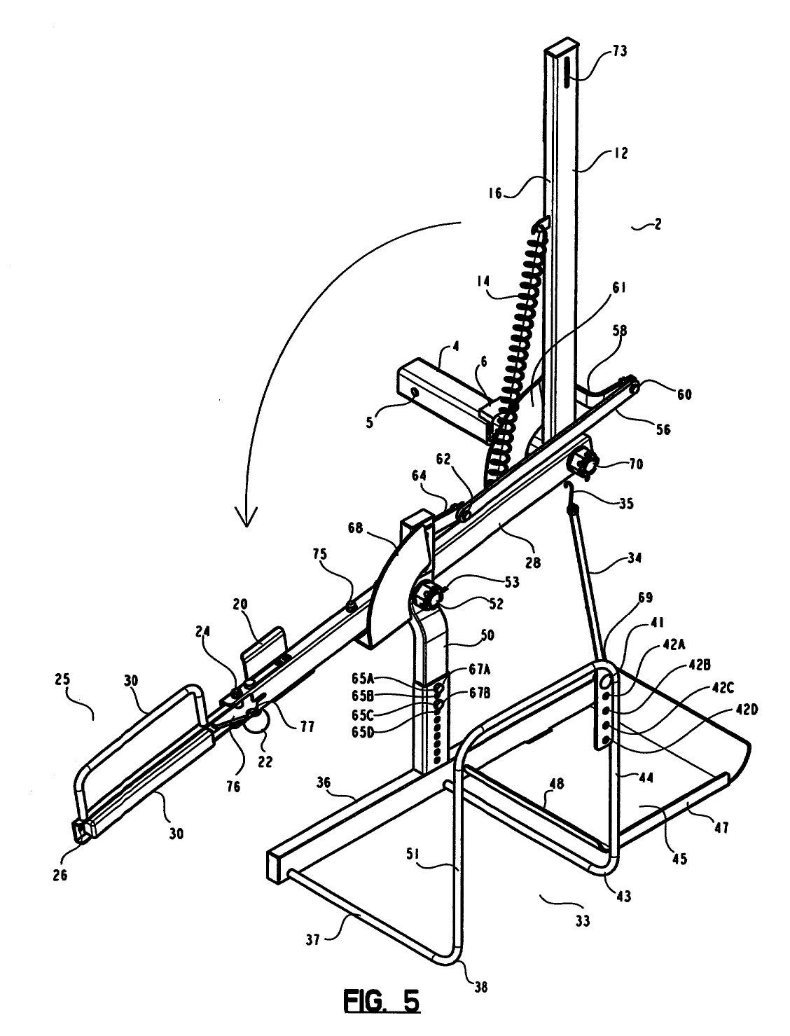

FIG. 5 is a view of wheelchair lift/carrier (2) of FIG. 1 in the loading position, wherein rotate arm shaft (28) has been rotated from vertical support shaft (12) in a counter clockwise arc to lower the bottom support shaft (36) to said loading position. Slit (79) is located at the top of vertical support shaft (12) for receiving cam (76) when in the storage lock position.

FIG. 5 additionally shows the second rotation means, e.g. pivot pin (70) located near the bottom of vertical support shaft (12) and rotate arm shaft (28) which rotatably connects the two.

In use, locking head (25) is disconnected from bundgy card (34) e.g. FIG. 1 and rotated in an upward direction after applying pressure to knob (22) to move the cam (76) from the storage lock position to the handle lock position. Rotate arm shaft (28) is rotated in a counter clockwise arc from the vertical support shaft. Swing arm shaft (50) remains in a vertical position during this procedure. Rotate arm shaft is rotated up to 90 degrees or more until bottom support shaft (36) is lowered to the wheelchair loading position, normally when the bottom support shaft (36) touches the ground. Once the wheelchair is folded and loaded into the wheelchair lift/carrier (2) with the small wheels resting in the tray (45) and the rear wheels resting in the rear wheel support (33). The procedure is reversed where spring (14) applies bias to aid in raising the wheelchair to the storage position. Rotate arm shaft is rotated in a clockwise arc toward the vertical support shaft (12) where lacking head (25) is placed in the storage lock position by applying pressure on knob (22) and rotating cam (76) to the storage lock position. Bundgy cord (34) is attached to the front of top support shaft (26) and the wheelchair is secured and ready for transportation.

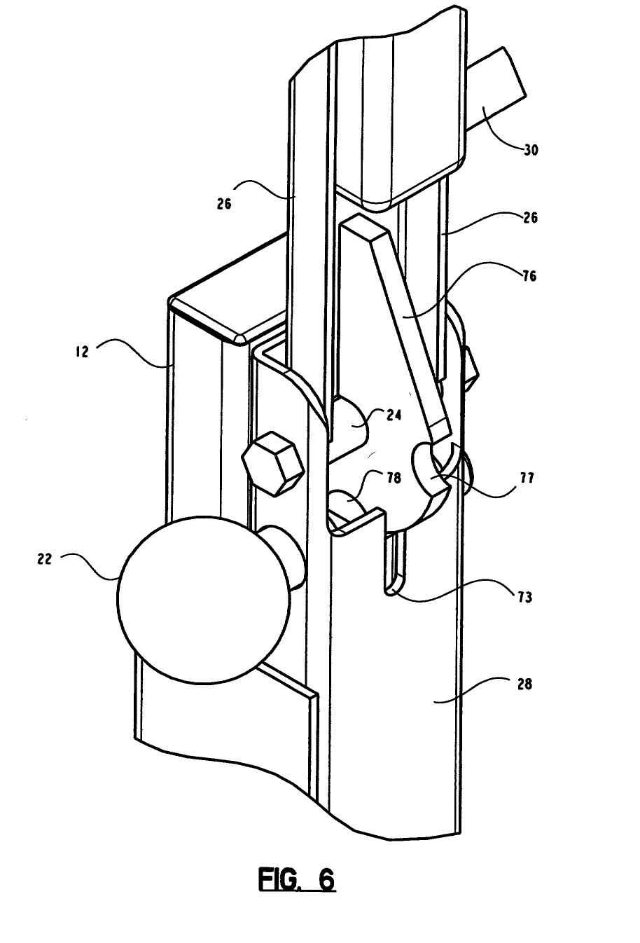

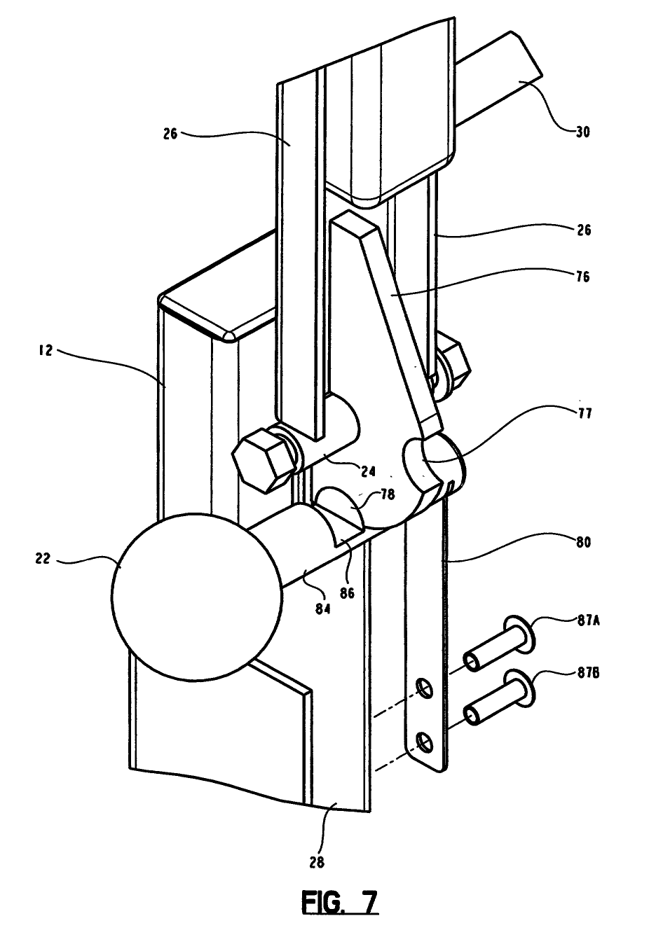

FIGS. 6 and 7 are side perspective, cut-away views of the top section of vertical support shaft (12) and rotate arm shaft (28) showing Cam (76) attached to the bottom side of upper support shaft (26). Upper support shaft (26) is rotatably attached to rotate arm shaft (28) by second rotation means (24) which is a pivot pin. Knob 22 is attached to locking pin (84) which is in the handle lock position in slot (78) of Cam (76). Slot (77) of said Cam (76) is the storage lock position thereof. Cam (76) is rotated through slot (73) to engage locking pin (84) at the desired slot. Attachment rivets 87A and 87B connect metal spring (80) to the side of rotate arm shaft (28) where the top of spring (80) engages slot (87) in locking pin (84). By applying pressure to knob (22) which is attached to locking pin (84), locking pin slot (86) disengages either slot (78) or slot (77) of Cam (76) and allows said Cam to be rotated either up or down to the desired position. When pressure is released on knob (22), locking pin (84) is automatically pushed back into the desired locking position due to the bias applied by spring (80). A portion of handle (30) is shown attached to upper support shaft (26).

In use, the circular portion of locking pin (84) engages handle lock slot (78) or (77) of Cam (76), depending upon whether the wheelchair lift is in the loading or unloading position, preventing said Cam (76) from rotating. Upper support shaft (26) may be rotated to the storage lock position by applying pressure to knob (22) which is attached to locking pin (84). Slot (86) of locking pin (84) slidably engages slot (78) of Cam (76). This action allows Cam (76) to rotate in a downward direction until storage position slot (77) is engage. By releasing the pressure on knob (22), slot (77) is automatically slidably engaged by locking pin (84) due to the based action of spring (80). Cam (76) can be rotated in an upward direction following the above-described procedure to again place the upper support shaft (26) in the handle lock position.

Obviously, many modification and variations of the invention, as hereinbefore set forth, may be made without departing from the spirit and score thereof, and therefore, only such limitations should be imposed as are indicated in the appended claims.

We claim

1. A wheelchair carrier mountable on the rear of a motor vehicle which comprises:
A vertical support shaft containing a trailer hitch attachment on the lower back side thereof, a rotate arm shaft pivotably attached to the bottom front side of the vertical support shaft with first rotation means, a top locking head with locking means pivotably attached to the bottom top section of rotate arm shaft with second rotation means, third rotation means pivotably connecting an off-set swing arm shaft to the rotate arm shaft; and a botom inverted T-shaped support shaft containing front wheelchair, wheel support wheelchair, means and rear support means attached to the bottom support shaft.

2. The wheelchair carrier of claim 1 wherein the vertical support shaft has an elongated, rectangular shaped configuration.

3. The wheelchair carrier of claim 1, wherein the rotate arm shaft has an elongated, rectangular shaped configuration.

4. The wheelchair carrier of claim 1, wherein the first rotation means connecting the vertical support shaft and the rotate arm shaft comprises a pivot pin.

5. The wheelchair carrier of claim 1, wherein the second rotation means connecting the locking head to the top section of the rotate arm shaft comprises a pivot pin.

6. The wheelchair carrier of claim 5, wherein the locking head comprises an inverted C-shaped handle connected to a top support shaft including a Cam with locking means.

7. The wheelchair carrier of claim 6, wherein the locking means of the Cam including a storage position slot and a handle position slot.

8. The wheelchair carrier of claim 7, wherein the locking means of the Cam includes a knob attached to a locking pin containing a slot that slidably engages the storage position slot and handle position slot of the Cam.

9. The wheelchair carrier of claim 8, wherein the locking pin is connected to a metal spring with bias tension.

10. The wheelchair carrier of claim 1, wherein the swing arm shaft has an off-set, elongated rectangular configuration.

11. The wheelchair carrier of claim 1, wherein the swing arm shaft is pivotably connected to the rotate arm shaft with third rotation means.

12. The wheelchair carrier of claim 1, wherein the swing arm shaft is pivotably connected to the vertical support shaft with linkage means.

13. The wheelchair carrier of claim 1, wherein the rotate arm shaft contains first, second and third stabilizing guide means for slidably engaging the vertical support shaft and the rotate arm shaft.

14. The wheelchair carrier of claim 1, wherein the inverted T-shaped bottom support shaft contains an elongated rectangular shaped configuration.

15. The wheelchair carrier of claim 14, wherein the bottom support shaft contains a front wheelchair wheel support tray attached to the right side.

16. The wheelchair carrier of claim 14, wherein the bottom support shaft contains a rear wheelchair wheel support unit attached to the left side.

17. The wheelchair carrier of claim 16, including a bundgy cord attached to rear wheel support structure and to the top support shaft of the locking head.

18. The wheelchair carrier of off-set claim 16, wherein the swing arm shaft is adjustably attached to the inverted T-shaped bottom support shaft.
